(19) United States
(12) Patent Application Publication
(10) Pub. No.: US 2026/0228509 A1
(43) Pub. Date: Aug. 6, 2026

(54) METHOD AND SYSTEM FOR GENERATING SOFT SENSOR TECHNICAL DATA BASED ON A DIFFUSION MODEL

(71) Applicants: Zhejiang University, Hangzhou (CN); Zhejiang ICsprout Semiconductor Co., Ltd., Hangzhou (CN)

(72) Inventors: YINING CHEN, Hangzhou (CN); Weiping Xie, Hangzhou (CN); Dawei Gao, Hangzhou (CN); Dingwei Chen, Hangzhou (CN)

(21) Appl. No.: 19/369,543

(22) Filed: Oct. 27, 2025

(30) Foreign Application Priority Data
Feb. 6, 2025 (CN) 202510132533.3

(51) Int. Cl. G06N 3/0475; G06N 3/08

(52) U.S. Cl. CPC G06N 3/0475; G06N 3/08

(57) ABSTRACT

Systems and methods generate soft-sensor data for semiconductor manufacturing using a regression-enhanced diffusion model. A training set is built from wafer-process data and measurement data from key steps. The diffusion model is trained iteratively; after each round, a subset of virtual samples is selected via non-dominated sorting and crowding-distance criteria and appended to the training set. After training, random Gaussian noise is provided to the model's reverse denoising module to synthesize virtual process data, which serve as soft-sensor technical data for the key steps. The approach improves modeling of complex mappings between process variables and measurement targets, yields representative, high-quality synthetic samples for training soft-sensor models, and enhances the performance and robustness of soft-sensor applications in semiconductor manufacturing.

### CROSS-REFERENCE TO RELATED APPLICATIONS

This application claims priority to Chinese Patent Application No. 202510132533.3, filed on Feb. 6, 2025, which is hereby incorporated by reference in its entirety.

### TECHNICAL FIELD

The present invention relates to the field of soft-sensor data generation, and more particularly to a method and system for generating soft-sensor technical data using a diffusion model.

### BACKGROUND

In the field of semiconductor manufacturing, precise control of process conditions is critical to achieving high product quality and maintaining operational efficiency. Conventional industrial practice relies on metrology steps in which selected wafers are sampled and physical characteristics—such as film thickness—are measured after key processing stages. The measurement results are then used to guide subsequent process adjustments with the objective of optimizing overall production performance. However, this approach typically relies on limited sampling—commonly only two or three wafers per lot—which results in insufficient process visibility and reduced control accuracy, thereby leading to variability in product quality. Furthermore, frequent physical metrology requires substantial time and costly equipment, which increases both production cost and cycle time and diminishes overall fabrication throughput.

To address these limitations, soft-sensor technology, also referred to as virtual metrology, has been developed. Soft sensors estimate critical dimensions or material properties without direct physical measurement, thereby reducing dependence on metrology equipment and lowering the frequency of costly measurement steps. Nevertheless, because physical measurements are reduced, the availability of labeled training data for constructing effective soft-sensor models is severely limited.

Recent efforts have investigated data-generation methods as a potential solution. However, existing approaches continue to exhibit several deficiencies:
1. Insufficient quality and diversity of generated data. Current generation methods generally lack diversity, and the quality of the generated data is inadequate to realistically represent production conditions. As a result, the generated samples provide limited benefit for training soft-sensor models, yielding only marginal improvements in predictive performance. Due to the poor quality and limited diversity of such data, resulting soft-sensor models demonstrate weak generalization capability and fail to adapt effectively to process variations or new operating conditions.
2. Inadequate learning of complex mappings and data distributions. Traditional generative models exhibit limitations in capturing the complex mapping relationships between process variables and target outputs. Consequently, the generated virtual samples do not accurately reflect actual process variability. In addition, existing models generally fail to learn both the feature and target distributions simultaneously, leading to generated data that lacks realism and representativeness, which in turn degrades the accuracy of the trained models.
3. Lack of effective optimization and selection mechanisms. The prior art does not provide an effective mechanism for optimizing the selection of generated data to achieve an appropriate balance between data distribution and diversity. This limitation reduces the efficacy of model training and prevents full utilization of generated virtual samples to enhance soft-sensor performance.

### SUMMARY

The present invention addresses deficiencies in existing data generation methods for soft sensor technology by proposing a data generation method and system based on a diffusion model. Said diffusion model is a regression-enhanced diffusion model, designated as REDM (Regression-Enhanced Diffusion Model), which is applicable to virtual data generation in soft sensor technology and is capable of broadly enhancing the predictive performance of existing soft sensor models.

The technical solutions employed in the present invention are described as follows:

In a first aspect, the present invention provides a diffusion model-based data generation method for soft sensor technology, comprising the steps of:
(1) collecting data from key semiconductor manufacturing steps, including process data and metrology data obtained during wafer fabrication, and utilizing the collected process data and metrology data as a training set;
(2) iteratively training a regression-enhanced diffusion model using said training set;

The regression-enhanced diffusion model includes a diffusion noise-adding module, a reverse denoising module, and a regression enhancement module incorporating a multi-head attention mechanism. The diffusion noise-adding module is configured to incrementally introduce random noise to process data within the training set to produce pure Gaussian noise data. The reverse denoising module is configured to progressively denoise and reconstruct the pure Gaussian noise data, thereby generating virtual process data. The regression enhancement module is configured to: generate virtual metrology data based on both real process data and virtual process data; and update parameters of the regression-enhanced diffusion model in accordance with a loss function comprising a loss between the virtual metrology data and actual metrology data, a reverse denoising loss, and a Lipschitz constraint loss.

During iterative training of the regression-enhanced diffusion model, the training set is updated following each training round by: dividing the virtual process data generated by the reverse denoising module into virtual sample subsets; selecting a portion of the virtual sample subsets according to non-dominated sorting results and crowding distance measurements; and adding the selected virtual sample subsets to the training set.
(3) generating virtual process data by providing random Gaussian noise as input to the reverse denoising module of the trained regression-enhanced diffusion model, and employing the generated output as soft sensor technology data for key semiconductor manufacturing steps.

Furthermore, said key semiconductor manufacturing steps comprise chemical vapor deposition steps, etching steps, and chemical mechanical polishing steps.

Furthermore, the process data of said key semiconductor manufacturing steps comprises a series of sensor readings.

Furthermore, the regression enhancement module comprises an encoder, a pre-trained multi-head attention module, and a linear prediction layer; wherein the real process data and virtual process data are first encoded by the encoder, subsequently processed by the pre-trained multi-head attention module to extract features, and finally fed into the linear prediction layer to generate virtual metrology data.

Furthermore, during iterative training of the regression-enhanced diffusion model, the loss functions for the reverse denoising module and the regression enhancement module are respectively defined as follows:

$${L}_{G} = {l}_{g} + α {l}_{d}^{′}$$

$${L}_{D} = {l}_{d} - β {l}_{d}^{′} + λ {I}_{p}$$

wherein L_{G} and L_{D} represent the total loss functions for the reverse denoising module and the regression enhancement module, respectively; l_{g} denotes the loss between the predicted noise and the actually added noise during the reverse denoising process; l_{d} represents the loss between the virtual metrology data predicted from the real process data and the actual metrology data; l_{d}′ represents the loss between the virtual metrology data predicted from the virtual process data and the actual metrology data; lₚ denotes the Lipschitz constraint loss; and α, β, λ are loss coefficients.

Furthermore, said selection of portions of the virtual sample subsets based on non-dominated sorting results and crowding distance results comprises:
calculating a Sliced-Wasserstein distance between each virtual sample subset and the training set;
computing an intra-subset sample similarity score for each virtual sample subset;
performing non-dominated sorting of the virtual sample subsets according to their respective Sliced-Wasserstein distance and sample similarity score to generate a Pareto front sequence, wherein each virtual sample subset is associated with a Pareto front level;
determining a crowding distance for each virtual sample subset within the Pareto front sequence;
selecting virtual sample subsets commencing from the first Pareto front level; if the quantity of virtual sample subsets at the current level is insufficient to satisfy a selection requirement, proceeding to select from subsequent levels; and for virtual sample subsets residing at the same Pareto front level, prioritizing selection of subsets exhibiting a greater crowding distance until said selection requirement is fulfilled.

In a second aspect, a system for generating soft sensor technology data based on a diffusion model is provided, said system being configured to perform the diffusion model-based soft sensor technology data generation method as described herein.

In a third aspect, an electronic device is provided, comprising: a processor; and a memory communicatively coupled to the processor and storing machine-executable instructions that, when executed by the processor, cause the processor to carry out the diffusion model-based soft sensor technology data generation method as described herein.

In a fourth aspect, a machine-readable storage medium is provided, having stored thereon machine-executable instructions that, when executed by at least one processor, cause the at least one processor to perform the diffusion model-based soft sensor technology data generation method as described herein.

The present invention yields the following advantageous effects:
(1) A regression-enhanced diffusion model is introduced, which enables the generation of representative, high-quality synthetic training samples. Utilizing the generated soft sensor technology data pertaining to key semiconductor manufacturing steps for training soft sensor models results in a significant improvement in the performance of existing soft sensor models.
(2) A multi-head attention mechanism is incorporated into the diffusion model, thereby enhancing its capacity to capture intricate mapping relationships within the data.
(3) The virtual process data produced by the reverse denoising module is partitioned into virtual sample subsets. Virtual samples demonstrating both distributional similarity and diversity are selected based on non-dominated sorting results and crowding distance measures. This approach optimizes the incorporation of synthetic samples into the training set and ensures an optimal balance between distribution fidelity and sample diversity.

### BRIEF DESCRIPTION OF THE DRAWINGS

FIG. 1 is a flowchart schematically illustrating a distortion-correction matching method for unsupervised scanning electron microscope (SEM) images, in accordance with an embodiment of the present invention.

FIG. 2 is a schematic diagram illustrating a training process of a REDM model, in accordance with an embodiment of the present invention.

FIG. 3 is a schematic diagram illustrating a sample-selection process, in accordance with an embodiment of the present invention.

FIG. 4 is a comparison chart illustrating target distributions of generated virtual samples and real samples, in accordance with an embodiment of the present invention.

### DESCRIPTION OF EMBODIMENTS

The following description is provided to disclose the present invention so that a person skilled in the art can carry out the invention.

The drawings are merely schematic illustrations of the present invention and are not necessarily drawn to scale. Some block diagrams shown in the drawings are functional entities and do not necessarily correspond to entities that are physically or logically independent. These functional entities may be implemented in software, or in one or more hardware modules or integrated circuits, or in different networks and/or processor devices and/or microcontroller devices.

The flow charts shown in the drawings are exemplary only and are not required to include all steps. For example, some steps may be further subdivided, while others may be combined or partially combined; therefore, the actual execution order may be changed according to the actual situation.

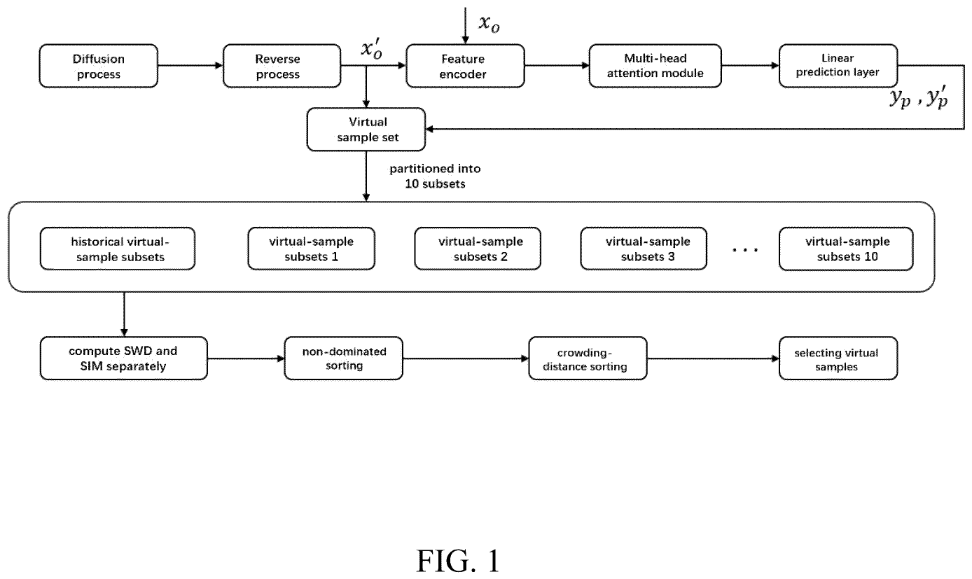

As shown in FIG. 1, the distortion-correction matching method for unsupervised scanning-electron-microscope images mainly comprises the following steps:

Step S1: Collecting real-time data from a Fault Detection and Classification system (FDC system) during wafer fabrication, including process data and measurement data from key semiconductor manufacturing steps, the process data being regarded as process variables and the measurement data as target variables.

The key semiconductor manufacturing steps comprise a chemical-vapor-deposition step (CVD), an etching step (ETCH), and a chemical-mechanical-polishing step (CMP).

The process data (process variables) of these key semiconductor manufacturing steps are a series of sensor values.

In a specific embodiment of the present invention, for example, in a CVD process, parameters such as lateral/top silane (SiH₄) gas flow, top/bias/lateral RF reflected power, deposition time, and front-line pressure are collected as process data, and the final deposition thickness is used as measurement data; Another example is the ETCH process; taking the polysilicon etch process as an example, high-energy plasma strikes the semiconductor surface to trigger chemical reactions that remove material, mainly through reactions between fluorine-containing gases and polysilicon, with the participation of NF₃, SF₆, CH₂F₂, HBr and Cl₂. All sensor data involved in this process are collected as process data, including gas type, gas flow, etch pressure and power, etc., and the critical dimension measured after etching is collected as measurement data; Still another example is the CMP process, where likewise all sensor data during the process are collected as process data, including chamber ID, wafer ID, chamber pressure, wafer rotation speed, slurry flow rate, processing stage, etc., and the average material removal rate of the process is collected as measurement data.

Step S2: Using the process data and measurement data of the key semiconductor manufacturing steps as the initial training-sample set, iteratively training a Regression-Enhanced Diffusion Model (hereafter REDM model), and updating the training-sample set after each iteration.

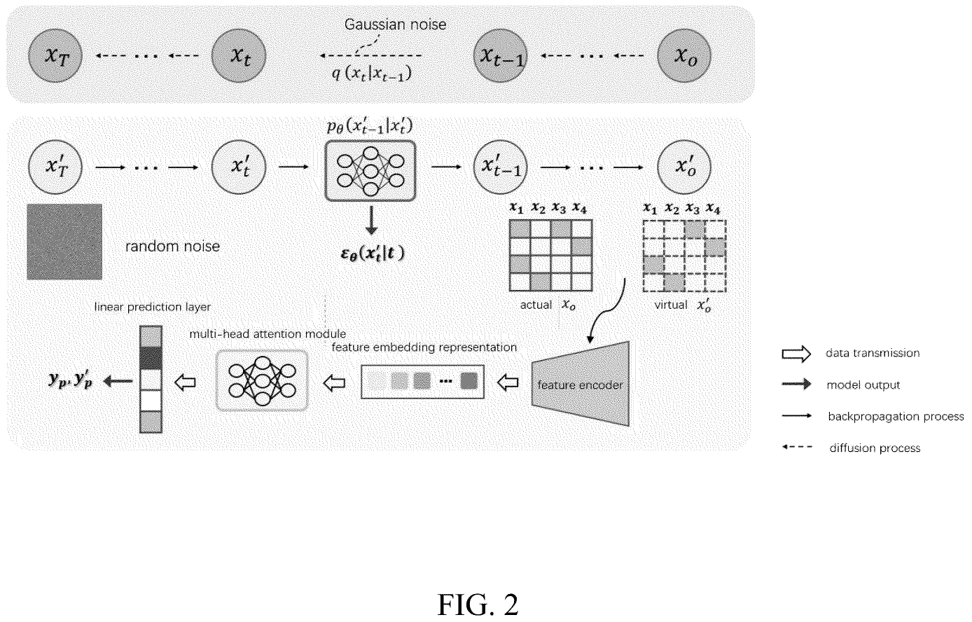

As shown in FIG. 2, the REDM model comprises four parts: a diffusion noise-adding module, a reverse denoising module, a regression-enhancement module, and a sample-selection module.

### (1) Diffusion Noise-Adding Module:

During the diffusion noise-adding process, the module progressively adds noise to the process-data matrix x₀ of the training samples. Starting from the data distribution q(x₀) noise is sampled from a predefined Gaussian distribution q(xₜ|xₜ₋₁), and the process-data matrix becomes increasingly blurred; when t is sufficiently large, the matrix turns into a pure Gaussian noise matrix. This process is defined as:

$$q ( {x}_{1 : T} \vert {x}_{0} ) = {\prod }_{t = 1}^{T} q ( {x}_{t} \vert {x}_{t - 1} )$$

Where x_{T} denotes the sequence of process-data matrices from time step 1 to T,
q(x_{1:T}|x₀) is the probability distribution of the matrix sequence given the initial state x₀, t is the time step, T is the total number of time steps, xₜ is the process-data matrix at time step t, and xₜ₋₁ is the process-data matrix at time step t−1.

The diffusion process progressively generates the noised process-data matrix x₁, x₂, . . . , x_{T}.

### (2) Reverse Denoising Module:

The reverse denoising process uses the random-noise data matrix

$${x}_{T}^{′}$$

as a latent variable and performs step-by-step denoising, predicting the noise component added at each step of the diffusion process and progressively generating a noise-feature matrix that serves as virtual process data

$${x}_{T}^{′} , {x}_{T - 1}^{′} , … , {x}_{0}^{′} .$$

Since the noise distribution

$${p}_{θ} ( {x}_{t - 1}^{′} \vert {x}_{t}^{′} )$$

is usually unknown, it is approximated by a neural network with parameters θ. The output of this network,

$${ϵ}_{θ} ( {x}_{t}^{′} \vert t )$$

is used to predict the “true” noise ϵ component of the virtual process-data matrix

$${x}_{T}^{′}$$

The loss function of the reverse denoising process can be expressed as:

$${l}_{g} = {E}_{{x}_{g} , ϵ , t} [ {( ϵ - {ϵ}_{θ} ( {x}_{t}^{′} \vert t ) )}^{2} ]$$

Where l_{g} is the loss between the predicted noise and the actually added noise in the reverse denoising process, Eₓ_{₀}_{ϵ,t} denotes the expectation over the initial data x₀, the noise ϵ, and the time step t, ϵ is the true noise component, and

$${ϵ}_{θ} ( {x}_{t}^{′} \vert t )$$

is the noise component predicted from the virtual process data

$${x}_{t}^{′}$$

at step t.

In the present invention, the reverse denoising module is regarded as the soft-sensor technical-data generation model; after training, it can be used to generate virtual process data for key semiconductor manufacturing steps, i.e., virtual samples that serve as soft-sensor technical data for subsequently training soft-sensor models.

### (3) Regression-Enhancement Module:

Traditional generative models perform poorly when capturing the complex mapping between process variables and target variables in key semiconductor manufacturing steps, so the generated virtual samples cannot accurately reflect real production variations. The present invention modifies the loss function of the generative model so that the generated samples are more beneficial to the soft-sensor model.

In the present invention, the regression-enhancement module is regarded as a discriminator model for soft-sensor technical data; it receives the virtual process-data matrix

$${x}_{0}^{′}$$

generated by the reverse denoising module and the real process-data matrix x₀, and produces virtual measurement data.

In a specific embodiment of the present invention, the regression-enhancement module comprises a feature encoder, a pre-trained multi-head attention module, and a linear prediction layer; the encoder may be a Transformer encoder, and the linear prediction layer may be a multilayer perceptron. The real and virtual process data are encoded by the encoder to obtain their feature embeddings in the feature space; these embeddings are then fed into the pre-trained multi-head attention module to extract features. By introducing a multi-layer multi-head attention mechanism, the model's ability to capture complex mappings is enhanced. Finally, the linear prediction layer generates virtual measurement data yₚ and

$${y}_{p}^{′} .$$

The loss is computed by comparing the virtual measurement data with the real measurement data:

$${l}_{d} = {E}_{{x}_{0} , y} [ {( y - {y}_{p} )}^{2} ]$$

$${l}_{d}^{′} = {E}_{{x}_{0}^{′} , y} [ {( y - {y}_{p}^{′} )}^{2} ]$$

Where l_{d} is the loss between the virtual measurement data predicted from real process data yₚ and the real measurement data y,

$${l}_{d}^{′}$$

is the loss between the virtual measurement data predicted from virtual process data

$${y}_{p}^{′}$$

and the real measurement data y, Eₓ_{₀}_{y} denotes the expectation over the real process data x₀ and the real measurement data y, and

$${E}_{{x}_{0}^{′} , y}$$

denotes the expectation over the virtual process data

$${x}_{0}^{′}$$

and the real measurement data y.

To prevent performance degradation and to improve stability, the present invention adds gradient penalty to enforce the Lipschitz constraint, and the loss is computed as:

$${l}_{p} = {E}_{x \sim {\tilde{P}}_{x}} [ {( {\vert {∇}_{x} D ( x ) \vert}_{2} - 1 )}^{2} ]$$

Where the gradient of the discriminator network is denoted by ∇ₓD(x), \tilde{P}ₓ is, sampled from the distribution interpolating virtual and real process data, and \tilde{P}ₓ is the expectation over that distribution E_{x~\tilde{P}}_{ₓ}.

The final loss functions of the reverse denoising module and the regression-enhancement module are obtained as:

$${L}_{G} = {l}_{g} + α {l}_{d}^{′}$$

$${L}_{D} = {l}_{d} - β {l}_{d}^{′} + λ {l}_{p}$$

Where L_{G} and L_{D} are the total losses of the reverse denoising module and the regression-enhancement module, l_{g} is the loss between the predicted noise and the actually added noise in the reverse denoising process, L_{D} is the loss between the virtual measurement data predicted from real process data and the real measurement data,

$${l}_{d}^{′}$$

is the loss between the virtual measurement data predicted from virtual process data and the real measurement data, lₚ is the Lipschitz-constraint loss, and α, β, γ are loss coefficients.

### (4) Sample-Selection Module:

In practical scenarios, even with a well-trained generative model, ensuring the quality of every virtual sample is challenging. Virtual samples that deviate from the original sample distribution may degrade the performance of the subsequent soft-sensor model, while overly similar samples provide no benefit for improving predictive performance. Maintaining sample diversity is therefore also a key consideration. After each round of generative training, the generated virtual samples—whose number equals that of the training-set samples—are partitioned into n subsets, forming a virtual-sample set G={g₁, g₂, . . . , gₙ} that is stored in a historical sample library, where gᵢ denotes the i_{g} virtual-sample subset, T denotes the training set, and m is the number of virtual samples in each subset gᵢ. The subsets may contain different numbers of samples; in the present embodiment equal sizes are used.

The Sliced-Wasserstein distance between each virtual-sample subset and the training set is computed as:

$$SWD ( {g}_{i} , T ) = {E}_{θ \sim {S}_{d - 1}} [ {W}_{p} ( ( {P}_{θ} {g}_{i} ) \#μ , ( {P}_{θ} T ) \# v ) ]$$

Where SWD(⋅) denotes the Sliced-Wasserstein distance, S_{d-1} is the unit sphere in d-dimensional space, θ is a direction vector uniformly sampled from the sphere, μ and v are the original multidimensional probability distributions of the virtual-sample subset gᵢ and the training set T, P_{θ} denotes linear projection, # push-forward measure, (P_{θ}gᵢ)#μ denotes the distribution μ through P_{θ}, Wₚ is the one-dimensional Wasserstein distance, and E_{θ~S}_{_{d−1}} is the expectation S_{d-1} over θ.

Since projecting onto all directions on the sphere is infeasible, the present embodiment uses 50 random projections to approximate SWD.

The intra-subset cosine similarity is computed as:

$$SIM ( {g}_{i} ) = - \frac{1}{{m}^{2}} {\sum }_{j = 1}^{m} {\sum }_{k = 1}^{m} \frac{{g}_{ij} \cdot {g}_{ik}}{\vert {g}_{ij} \vert \vert {g}_{ik} \vert}$$

Where gᵢⱼ and gᵢₖ are the j-th and k-th virtual samples in the l-th virtual-sample subset.

Based on the SWD and SIM scores of each virtual-sample subset, non-dominated sorting (NDS) is performed in the historical sample library to identify the Pareto front at each level, yielding a Pareto-front sequence in which every virtual-sample subset is assigned a Pareto-front rank. For each subset, its crowding distance in the objective space is computed to measure sparsity; a larger crowding distance indicates that the subset lies in a sparser region.

When selecting virtual-sample subsets, start from the first Pareto-front level; if the number of subsets at the current level is insufficient, continue selection from the next level. Among subsets at the same Pareto-front level, those with larger crowding distances are preferred, thereby enhancing the diversity of the virtual-sample set until the required number is reached. In each training iteration, the selected virtual-sample subsets are added to the training set to form synthetic samples.

(3) Using random Gaussian noise as input, virtual process data are generated by the reverse denoising module of the trained regression-enhanced diffusion model, and the generated results are used as soft-sensor technical data for the key semiconductor manufacturing steps.

To quantitatively evaluate the performance of the REDM model, the present invention compares it with existing models. Because of the large number of generative models, only the leading method in each paradigm was selected for assessment, namely TVAE, CTGAN, SMOTE, and TabDDPM as baseline models.

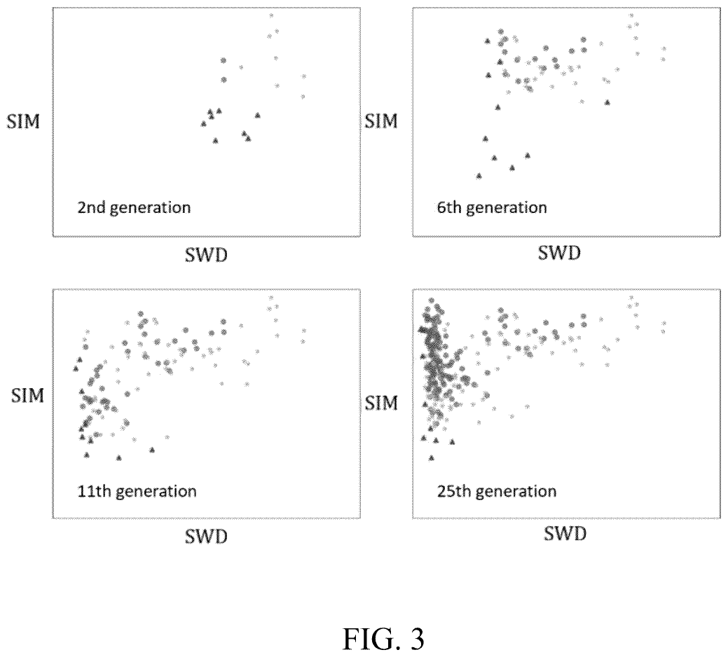

REDM hyper-parameters: number of iterations is set to 30; in each iteration the generated virtual samples are split into 10 parts for sample selection. FIG. 3 illustrates the evolution of the selected subsets during training: red indicates currently selected subsets, yellow historically selected ones, and blue unselected ones. It can be observed that as iterations proceed, the SWD and SIM scores of the virtual-sample subsets gradually move toward the lower-left corner, and the red samples are scattered along the final Pareto frontier, indicating that the generated virtual samples continuously learn the distribution of real samples, the distributional distance between the two gradually decreases, and the finally selected virtual-sample subsets are more diverse and are not merely copies of real samples.

Machine-learning utility evaluation: Machine-learning utility is used as the primary metric to quantify the performance of regression models trained on synthetic data when tested on the real test set. Three evaluation protocols—Random Forest, XGBoost, and CatBoost—are employed. In this embodiment, datasets from CVD, ETCH, CMP processes were collected, designated CVD-1, CVD-2V, CVD-3, CVD-4, ETCH-1, CMP-1, CMP-2, CMP-3.

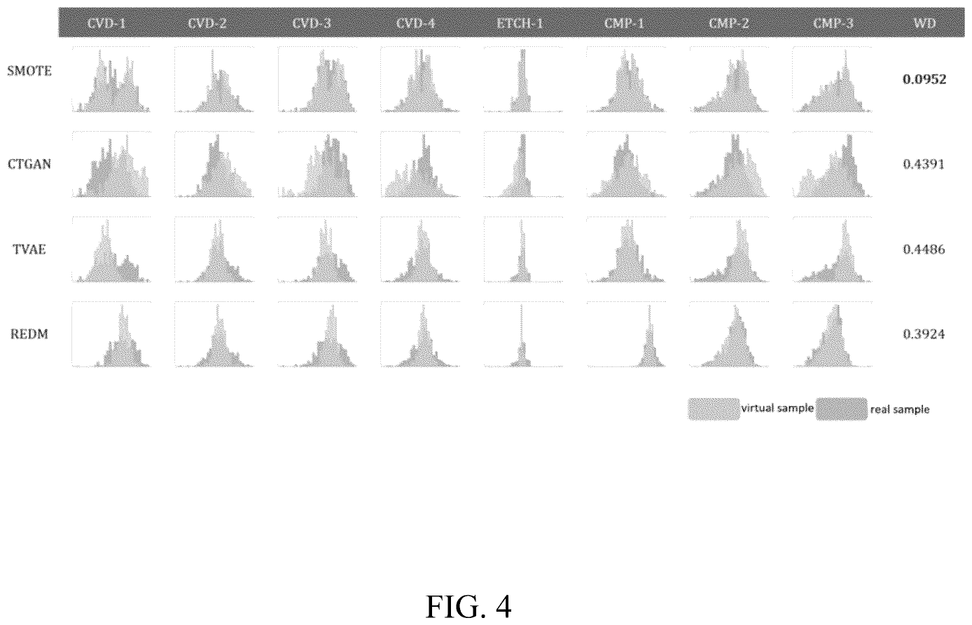

Quality assessment of generated virtual samples: Kernel-density estimation is used to obtain the probability-density curves of virtual samples, enabling an effective comparison between the distributions of virtual and real samples. FIG. 4 shows the target-variable distributions of data generated by REDM, CTGAN, TVAE and SMOTE versus real data. The first eight columns display the distributional discrepancy between generated and real target variables for each individual dataset under the four generative models; the last column gives the average Wasserstein distance (WD) between generated and real target variables across the eight datasets. SMOTE yields the smallest WD and the highest distributional similarity because it is interpolation-based SMOTE and effectively copies real data. REDM achieves a WD smaller than CTGAN and TVAE, indicating that REDM samples are more similar to real data than those of CTGAN and TVAE, while being more diverse than SMOTE samples.

Comparison of generative models: In this experiment, REDM is split into two variants: REDM-I (without the sample-selection module) and REDM-II (the complete regression-enhanced diffusion model). For each generative model, a synthetic dataset is sampled, and the R² R² score of regression models is evaluated on the real test set.

Tables 1, 2, and 3 present the machine-learning utility values under different evaluation protocols. Results are averaged over five random seeds.

TABLES 1

| | CVD-1 | CVD-2 | CVD-3 | CVD-4 | ETCH-1 | CMP-1 | CMP-2 | CMP-3 |
|---|---|---|---|---|---|---|---|---|
| TVAE | 0.652 ± 0.008 | 0.510 ± 0.010 | 0.508 ± 0.005 | 0.550 ± 0.011 | 0.787 ± 0.044 | 0.257 ± 0.032 | 0.782 ± 0.012 | 0.839 ± 0.004 |
| CTGAN | 0.668 ± 0.005 | 0.539 ± 0.013 | 0.495 ± 0.018 | 0.563 ± 0.016 | 0.770 ± 0.037 | 0.201 ± 0.038 | 0.769 ± 0.007 | 0.835 ± 0.008 |
| SMOTE | 0.663 ± 0.023 | 0.545 ± 0.015 | 0.495 ± 0.001 | 0.556 ± 0.032 | 0.792 ± 0.017 | 0.187 ± 0.056 | 0.755 ± 0.043 | 0.830 ± 0.000 |
| TabDDPM | 0.667 ± 0.028 | 0.542 ± 0.081 | 0.494 ± 0.016 | 0.542 ± 0.070 | 0.764 ± 0.055 | 0.179 ± 0.048 | 0.798 ± 0.020 | 0.814 ± 0.007 |
| REDM-I | 0.690 ± 0.006 | 0.592 ± 0.009 | 0.504 ± 0.006 | 0.578 ± 0.010 | 0.840 ± 0.019 | 0.259 ± 0.011 | 0.777 ± 0.005 | 0.833 ± 0.003 |
| REDM-II | 0.691 ± 0.009 | 0.594 ± 0.010 | 0.537 ± 0.005 | 0.598 ± 0.014 | 0.859 ± 0.020 | 0.322 ± 0.026 | 0.795 ± 0.003 | 0.849 ± 0.003 |
| BSL(Xgboost) | 0.659 ± 0.001 | 0.546 ± 0.003 | 0.498 ± 0.003 | 0.558 ± 0.000 | 0.776 ± 0.006 | 0.214 ± 0.034 | 0.798 ± 0.005 | 0.842 ± 0.003 |

TABLES 2

| | CVD-1 | CVD-2 | CVD-3 | CVD-4 | ETCH-1 | CMP-1 | CMP-2 | CMP-3 |
|---|---|---|---|---|---|---|---|---|
| TVAE | 0.645 ± 0.014 | 0.479 ± 0.005 | 0.496 ± 0.014 | 0.488 ± 0.008 | 0.757 ± 0.010 | 0.296 ± 0.011 | 0.781 ± 0.012 | 0.812 ± 0.007 |
| CTGAN | 0.650 ± 0.016 | 0.526 ± 0.006 | 0.479 ± 0.019 | 0.511 ± 0.005 | 0.788 ± 0.012 | 0.311 ± 0.032 | 0.790 ± 0.008 | 0.812 ± 0.009 |
| SMOTE | 0.621 ± 0.005 | 0.520 ± 0.006 | 0.502 ± 0.001 | 0.501 ± 0.004 | 0.725 ± 0.008 | 0.299 ± 0.007 | 0.765 ± 0.005 | 0.798 ± 0.002 |
| TabDDPM | 0.662 ± 0.034 | 0.502 ± 0.049 | 0.431 ± 0.020 | 0.489 ± 0.009 | 0.733 ± 0.001 | 0.324 ± 0.009 | 0.796 ± 0.001 | 0.807 ± 0.007 |
| REDM-I | 0.677 ± 0.003 | 0.523 ± 0.006 | 0.508 ± 0.005 | 0.542 ± 0.007 | 0.828 ± 0.025 | 0.300 ± 0.020 | 0.796 ± 0.006 | 0.780 ± 0.009 |
| REDM-II | 0.673 ± 0.007 | 0.541 ± 0.006 | 0.546 ± 0.005 | 0.520 ± 0.008 | 0.840 ± 0.022 | 0.339 ± 0.022 | 0.787 ± 0.005 | 0.835 ± 0.006 |
| BSL(RF) | 0.641 ± 0.002 | 0.535 ± 0.005 | 0.484 ± 0.003 | 0.517 ± 0.006 | 0.731 ± 0.003 | 0.321 ± 0.014 | 0.787 ± 0.004 | 0.818 ± 0.006 |

TABLES 3

| | CVD-1 | CVD-2 | CVD-3 | CVD-4 | ETCH-1 | CMP-1 | CMP-2 | CMP-3 |
|---|---|---|---|---|---|---|---|---|
| TVAE | 0.644 ± 0.006 | 0.513 ± 0.006 | 0.485 ± 0.006 | 0.490 ± 0.010 | 0.732 ± 0.011 | 0.266 ± 0.010 | 0.709 ± 0.012 | 0.781 ± 0.013 |
| CTGAN | 0.595 ± 0.006 | 0.473 ± 0.008 | 0.442 ± 0.020 | 0.422 ± 0.024 | 0.694 ± 0.032 | 0.256 ± 0.012 | 0.674 ± 0.003 | 0.736 ± 0.016 |
| SMOTE | 0.682 ± 0.003 | 0.555 ± 0.007 | 0.513 ± 0.002 | 0.557 ± 0.002 | 0.800 ± 0.003 | 0.262 ± 0.001 | 0.735 ± 0.008 | 0.811 ± 0.002 |
| TabDDPM | 0.668 ± 0.010 | 0.525 ± 0.012 | 0.478 ± 0.005 | 0.482 ± 0.073 | 0.735 ± 0.027 | 0.254 ± 0.017 | 0.690 ± 0.020 | 0.747 ± 0.039 |
| REDM-I | 0.681 ± 0.007 | 0.577 ± 0.006 | 0.542 ± 0.007 | 0.559 ± 0.007 | 0.812 ± 0.012 | 0.288 ± 0.007 | 0.714 ± 0.008 | 0.755 ± 0.009 |
| REDM-II | 0.696 ± 0.007 | 0.576 ± 0.000 | 0.560 ± 0.004 | 0.561 ± 0.002 | 0.811 ± 0.005 | 0.323 ± 0.002 | 0.801 ± 0.006 | 0.833 ± 0.003 |
| BSL(Catboost) | 0.670 ± 0.008 | 0.567 ± 0.000 | 0.521 ± 0.000 | 0.551 ± 0.001 | 0.790 ± 0.000 | 0.290 ± 0.000 | 0.801 ± 0.036 | 0.828 ± 0.013 |

Under each evaluation protocol, REDM-I outperforms TVAE, CTGAN, SMOTE, and TabDDPM on most datasets, demonstrating that incorporating the mapping between features and target variables into a generative model improves the machine-learning utility of synthetic samples. REDM-II further enhances this performance through selective sampling. While SMOTE, as a lightweight generative approach, exhibits competitive distributional similarity, its samples are essentially replicas of real data and contribute little to improving machine-learning utility. In contrast, REDM-generated data incorporate controlled noise and transformations, which enhance the robustness of regression models to variations and noise, resulting in improved performance on real-world tests. Among the baseline regressors, CatBoost achieves the best results; in practical semiconductor manufacturing, only the top-performing regressor is typically considered. REDM-II improves the average R² score of CatBoost by 4.53%.

The present invention further provides a system for generating soft-sensor technical data based on a diffusion model, configured to implement the above-described method. As used herein, terms such as “module” and “unit” refer to any combination of hardware and/or software capable of performing the specified functions. While the system may preferably be implemented in software, implementation in hardware, or a combination of hardware and software, is also possible.

According to one embodiment, the system comprises:

A wafer-fabrication data-collection module, configured to collect data generated during wafer fabrication, including process data and measurement data from key semiconductor manufacturing steps, and to provide the collected data as a training set.

A regression-enhanced diffusion model module comprising: a diffusion noise-adding module operative to progressively introduce random noise into process data of a training set to produce pure Gaussian noise data; a reverse denoising module operative to incrementally denoise and reconstruct said pure Gaussian noise data, thereby generating virtual process data; and a regression enhancement module incorporating a multi-head attention mechanism, operative to generate virtual metrology data utilizing both actual process data and said virtual process data.

A regression-enhanced diffusion-model training module, configured to iteratively train the regression-enhanced diffusion model using the training set, updating model parameters based on the loss between virtual and real measurement data, reverse-denoising loss, and a Lipschitz-constraint loss. After each training iteration, the module updates the training set by partitioning virtual process data into subsets, selecting a portion of these subsets based on non-dominated sorting and crowding-distance results, and adding the selected subsets to the training set.

A soft-sensor technical-data generation module, configured to generate virtual process data from random Gaussian noise using the trained regression-enhanced diffusion model, and to provide the generated data as soft-sensor technical data for key semiconductor manufacturing steps.

With respect to the system embodiment, which substantially corresponds to the method embodiment described herein, reference should be made to the corresponding portions of the method embodiment description for applicable details. By way of example, said regression enhancement module comprises:
an encoder module operative to encode both real process data and virtual process data;
a pre-trained multi-head attention module operative to extract features from the encoded real process data and encoded virtual process data;
a linear prediction layer module operative to generate virtual metrology data based on the features derived from the encoded real process data and encoded virtual process data.

Detailed implementations of the remaining modules are omitted here for brevity. The system embodiments described above are intended to be illustrative only. Components described as separate units may or may not be physically separate, and elements displayed as units may or may not correspond to physical units; that is, they may be located in one place or distributed across multiple network elements. Some or all modules may be selected and implemented in accordance with practical requirements to accomplish the objectives of the solutions in the present invention. Those skilled in the art may comprehend and implement the present invention without creative effort.

Embodiments of the system according to the present invention may be applied to any device having data processing capabilities, such as a computer or other device or apparatus. The system embodiments may be implemented in software, hardware, or a combination thereof. In a software implementation, as a logical device, the system is formed when a processor of a device having data processing capabilities reads corresponding computer program instructions from a non-volatile memory into a memory and executes them.

An embodiment of the present invention further provides an electronic device comprising a memory and a processor, wherein the memory is configured to store computer program instructions, and

wherein the processor is configured to execute said computer program instructions to perform the diffusion model-based soft sensor technology data generation method as described herein.

An embodiment of the present invention further provides a computer-readable storage medium having stored thereon program instructions which, when executed by a processor, cause the processor to carry out the diffusion model-based soft sensor technology data generation method as described herein.

The computer-readable storage medium may comprise an internal storage unit of a data processing device according to any preceding embodiment, including but not limited to a hard disk or memory. Alternatively, the computer-readable storage medium may comprise an external storage device associated with a data processing device, such as a plug-in hard disk, a Smart Media Card (SMC), an SD card, or a Flash Card. In some implementations, the computer-readable storage medium may include both internal and external storage components of a data processing device. The computer-readable storage medium is adapted to store the computer program instructions, additional programs, and data required by the data processing device, and may further provide temporary storage for data that has been output or is scheduled for output.

It is to be understood that the embodiments and drawings described above are provided for illustrative purposes only and do not limit the scope of the present application. A person skilled in the art may adapt the teachings of the present application to other analogous situations without inventive effort. Furthermore, although the development process may involve complex and time-consuming work, modifications-such as those pertaining to design, manufacturing, or production-made by a person skilled in the art based on the technical disclosures herein are considered routine technical measures and should not be interpreted as indicating insufficiency of the disclosure. Various modifications and improvements may be made without departing from the spirit of the present application, and all such variations shall fall within the scope of protection defined by the appended claims.

What is claimed is:

1. A method for generating soft-sensor technical data based on a diffusion model, characterized by comprising the following steps:
(1) collecting data from a wafer manufacturing process, the data comprising process data and metrology data obtained from key semiconductor manufacturing steps, and utilizing the collected process data and metrology data to form a training set;
(2) iteratively training a regression-enhanced diffusion model using said training set;
The regression-enhanced diffusion model includes a diffusion noise-adding module, a reverse denoising module, and a regression enhancement module incorporating a multi-head attention mechanism. The diffusion noise-adding module is operative to incrementally introduce random noise to process data within the training set, thereby producing pure Gaussian noise data. The reverse denoising module is operative to progressively denoise and reconstruct the pure Gaussian noise data to generate virtual process data. The regression enhancement module is operative to: generate virtual metrology data utilizing both actual process data and the virtual process data; and update parameters of the regression-enhanced diffusion model based on a loss function that includes a measurement loss between the virtual metrology data and actual metrology data, a reverse denoising loss, and a Lipschitz constraint loss.
Throughout iterative training of the regression-enhanced diffusion model, the training set is refreshed following each training iteration by: dividing the virtual process data produced by the reverse denoising module into virtual sample subsets; choosing selected virtual sample subsets according to non-dominated sorting outcomes and crowding distance evaluations; and integrating the chosen virtual sample subsets into the training set.
(3) Virtual process data is generated by inputting random Gaussian noise into the reverse denoising module of the trained regression-enhanced diffusion model, wherein said generated virtual process data serves as soft sensor technology data for key semiconductor manufacturing steps.

2. The method of claim 1, wherein process data for a critical semiconductor manufacturing step comprises a series of sensor readings.

3. The method for generating soft sensor technology data based on a diffusion model as recited in claim 1, wherein said regression enhancement module includes an encoder, a pre-trained multi-head attention module, and a linear prediction layer; wherein both the real process data and virtual process data are initially encoded by the encoder, then processed by the pre-trained multi-head attention module for feature extraction, and subsequently provided to the linear prediction layer to produce virtual metrology data.

4. The method for generating soft sensor technology data based on a diffusion model as recited in claim 1, wherein during iterative training of the regression-enhanced diffusion model, the loss functions for the reverse denoising module and the regression enhancement module are respectively defined as follows:
$${L}_{G} = {l}_{g} + α {l}_{d}^{′}$$
$${L}_{D} = {l}_{d} - β {l}_{d}^{′} + λ {l}_{p}$$
wherein L_{G} and L_{D} correspond to the total loss values for the reverse denoising module and the regression enhancement module, respectively; l_{g} designates the loss between predicted noise and actually introduced noise during the reverse denoising procedure; l_{d} indicates the loss between virtual metrology data predicted from real process data and actual metrology data;
$${l}_{d}^{′}$$
indicates the loss between virtual metrology data predicted from virtual process data and actual metrology data; lₚ designates the Lipschitz constraint loss; and α, β, λ represent loss coefficients.

5. The method for generating soft sensor technology data based on a diffusion model as recited in claim 1, wherein said selection of virtual sample subsets based on non-dominated sorting results and crowding distance metrics comprises:
calculating a Sliced-Wasserstein distance between each virtual sample subset and the training set;
determining an intra-subset sample similarity score for each virtual sample subset;
performing non-dominated sorting of the virtual sample subsets according to their respective Sliced-Wasserstein distance and sample similarity score to generate a Pareto front sequence, wherein each virtual sample subset is associated with a Pareto front level;
computing a crowding distance for each virtual sample subset within the Pareto front sequence;
selecting virtual sample subsets commencing from the first Pareto front level; if the quantity of virtual sample subsets at the current level is insufficient to satisfy a selection requirement, proceeding to select from subsequent levels; and for virtual sample subsets residing at the same Pareto front level, prioritizing selection of subsets exhibiting a greater crowding distance until said selection requirement is fulfilled.

6. A system for generating soft sensor technology data based on a diffusion model, the system comprising:
A wafer manufacturing process data collection module configured to collect data from a wafer manufacturing process, the data including process data and metrology data obtained from key semiconductor manufacturing steps, and to form a training set from the collected process data and metrology data;
A regression-enhanced diffusion model module comprising: a diffusion noise-adding module operative to incrementally introduce random noise into process data of the training set, thereby producing pure Gaussian noise data; a reverse denoising module operative to progressively denoise and reconstruct the pure Gaussian noise data to generate virtual process data; and a regression enhancement module incorporating a multi-head attention mechanism, operative to generate virtual metrology data utilizing both actual process data and the virtual process data;
A regression-enhanced diffusion model training module configured to: iteratively train the regression-enhanced diffusion model using the training set; update parameters of the regression-enhanced diffusion model based on a loss function comprising: a measurement loss between the virtual metrology data and actual metrology data, a reverse denoising loss, and a Lipschitz constraint loss; and update the training set following each training iteration by: partitioning the virtual process data produced by the reverse denoising module into virtual sample subsets; selecting a portion of the virtual sample subsets according to non-dominated sorting outcomes and crowding distance evaluations; and integrating the selected virtual sample subsets into the training set;
A soft sensor technology data generation module operative to: generate virtual process data by processing random Gaussian noise through the reverse denoising module of the trained regression-enhanced diffusion model; and employ the generated virtual process data as soft sensor technology data for key semiconductor manufacturing steps.

7. The system for generating soft sensor technology data based on a diffusion model as recited in claim 6, wherein the regression enhancement module comprises:
an encoder module operative to encode both real process data and virtual process data;
a pre-trained multi-head attention module operative to extract features from the encoded real process data and the encoded virtual process data;
a linear prediction layer module operative to generate virtual metrology data based on the features derived from the encoded real process data and the encoded virtual process data.

8. An electronic device comprising: a processor; and a non-transitory computer-readable storage medium communicatively coupled to the processor and storing instructions that, when executed by the processor, cause the processor to perform the diffusion model-based soft sensor technology data generation method according to claim 1.

9. A machine-readable storage medium having stored thereon machine-executable instructions that, when executed by at least one processor, cause the at least one processor to perform the method for generating soft sensor technology data based on a diffusion model according to claim 1.
